(19) United States
(12) Patent Application Publication
(10) Pub. No.: US 2009/0031071 A1
(43) Pub. Date: Jan. 29, 2009

(54) METHOD FOR ACQUIRING RELEVENT INFORMATION TO AN OBJECT USING AN INFORMATION ACCESS TAG

(76) Inventor: Fu-Sheng CHIU, Taipei city (TW)

Correspondence Address: SINORICA, LLC, 528 FALLSGROVE DRIVE, ROCKVILLE, MD, 20850, US

(21) Appl. No.: 12/034,277

(22) Filed: Feb. 20, 2008

(30) Foreign Application Priority Data
Jul. 27, 2007 (TW) 96127485

(51) Int. Cl. G06F 12/00

(52) U.S. Cl. 711/100; 711/E12.001

(57) ABSTRACT

A method for retrieving relevant information about an object is disclosed. An information access tag is associated with the object. Relevant information or data about the object are store on a server. The information access tag comprises a link pointing to the address of the server. When a user uses a mobile electronic device to read the information access tag the link is decoded and the electronic device connects to the server via a network. The relevant information is downloaded and displayed on the electronic device for the user to interact with the information or data.

### BACKGROUND OF THE INVENTION

1. Field of the Invention

The present invention relates to acquiring information. More specifically, the present invention discloses a method for acquiring information relevant to an object or product using an information access tag containing a link to stored information on a network server.

2. Description of the Prior Art

A wide variety of products are available to consumers. However, information about each individual product is limited to the amount of data that can be printed on the package or container of the product. This shortage of adequate product information is a disadvantage for consumers and retailers.

Additionally, labels or packages printed in various languages may be unreadable by many consumers leaving the consumer to guess about product contents or product specifications.

Furthermore, if a consumer wants to know more about a product they need to manually locate the information. For example, the consumer may have to visit the retailer and discuss the product with a clerk or visit the manufacturer's web site and navigate the web site to try to find the information. This is not only time consuming but also frustrating for consumers who want the information immediately.

Moreover, documentation about a product is often lost or misplaced. After a period of time if there is a question or problem with the product the user must request an additional copy of the documentation. To do so the consumer must take note of such data as the brand name, model number, etc. and provide it to the manufacturer who must then locate the documentation. This is highly inconvenient and ineffective.

Therefore, there is need for an improved method of conveniently acquiring relevant information about an object or product by a user with a mobile electronic device.

### SUMMARY OF THE INVENTION

To achieve these and other advantages and in order to overcome the disadvantages of the conventional method in accordance with the purpose of the invention as embodied and broadly described herein, the present invention provides a method of acquiring relevant information about an object by reading data of an information access tag using a mobile electronic device.

An information access tag is attached or printed on an object, for example, a consumer product. The information access tag comprises a link that points to a location on a network where additional information relevant to the object is stored. A user device reads the link and accesses the network. The relevant information is then located and downloaded to the user device and displayed. As a result, a user can easily acquire additional information about the object using their mobile electronic device.

The mobile electronic device comprises, for example, a cellular telephone, a personal digital assistant (PDA), or a portable computer. The information access tag comprises, for example, a quick response (QR) code, radio frequency (RF) tag, radio frequency identification (RFID) tag, universal product code (UPC), or other type of coding capable of relaying a link to a mobile electronic device.

An object of the present invention is to provide a method for conveniently retrieving information or data related or relevant to an object such as a product. A user simply uses their portable device to read data of an information access tag associated with or attached to an object or printed in a print medium. The method automatically retrieves the relevant information and displays it for the user. The user is not required to manually input any data, however the user can make certain selections of which type of information to retrieve if desired.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating an information retrieval system according to an embodiment of the present invention;

FIG. 2A is a drawing illustrating an example of a QR code;

FIG. 2B is a drawing illustrating an example of an RFID tag;

FIG. 2C is a drawing illustrating an example of a UPC code; and

FIGS. 3A-3C are flowcharts illustrating methods of acquiring information relevant to an object according to embodiments of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

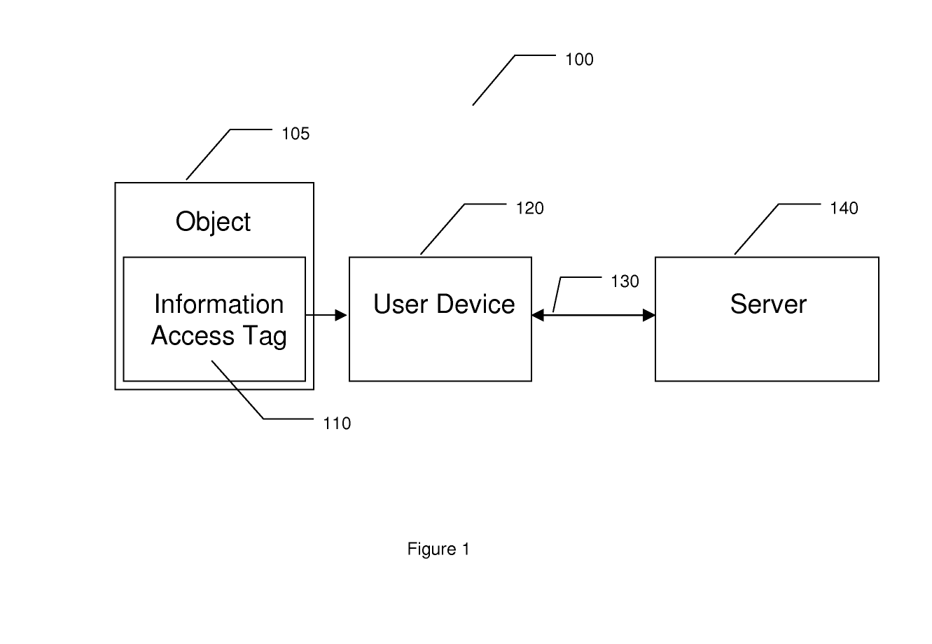

Refer to FIG. 1, which is a drawing illustrating an information retrieval system according to an embodiment of the present invention.

In the embodiment shown in FIG. 1 the information retrieval system 100 comprises an object 105, an information access tag 110, a user device 120, a network 130, and a network server 140. Information about an object 105 is stored on the network server 140. The information comprises, for example, object explanation, warranty information, competitive pricing, tour information, tutorial, product description, object description, or other information relevant to the object 105. A link to the information is embedded in, stored in, or printed in the information access tag 110.

The user device 120 reads the information access tag 110 and acquires the link to the information. The user device 120 then accesses the network server 140 via the network 130 and retrieves the information relevant to the object 105. Once the information is downloaded to the user device 120 the information is displayed. As a result, a user can easily obtain additional information relevant to an object.

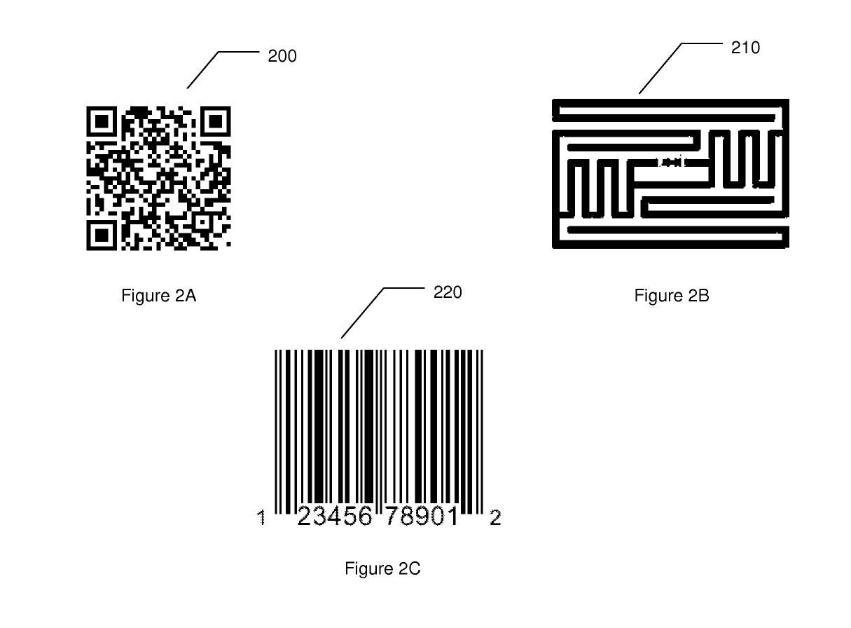

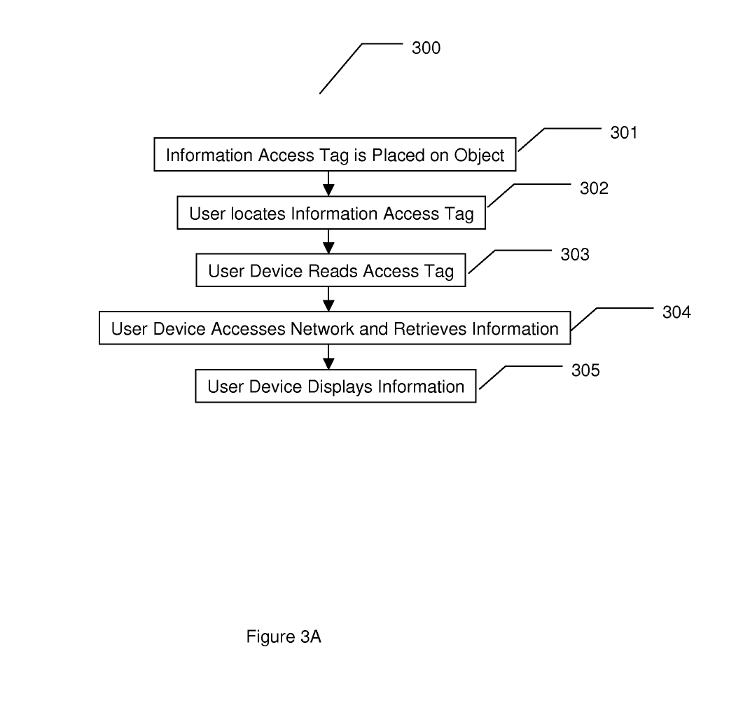

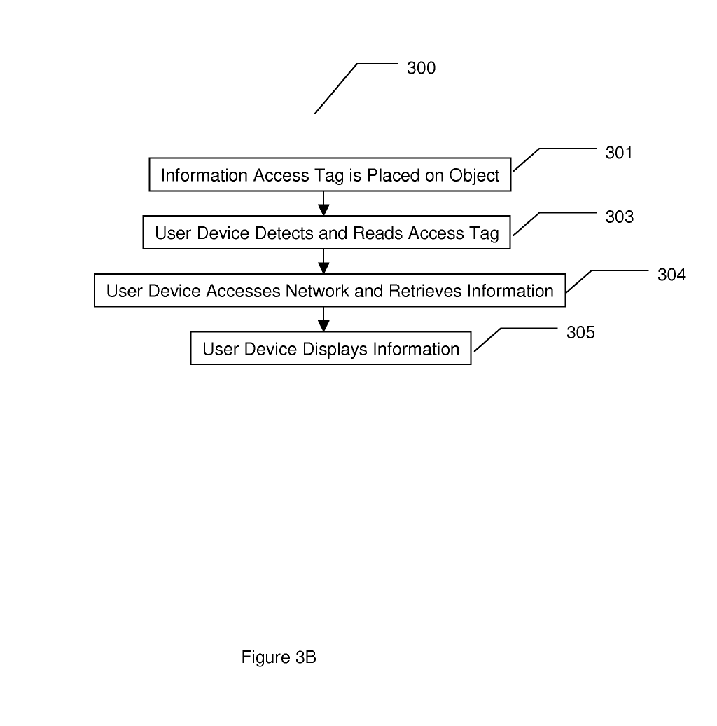

Refer to FIG. 2A, which is a drawing illustrating an example of a QR code, to FIG. 2B, which is a drawing illustrating an example of an RFID tag, and to FIG. 2C, which is a drawing illustrating an example of a UPC code.

In an embodiment of the present invention the information access code is a QR code 200. The QR code 200 is printed or attached to an object, for example, printed in a magazine or newspaper or printed on a label. The data encoded into the QR code 200 comprises a link, for example, a universal resource locater (URL) pointing to the network location where the relevant information is stored. For example, a QR code is printed in a magazine advertisement for a product. A user simply uses their mobile electronic device to read the QR code and the electronic device accesses the network server, retrieves information about the product, and displays the information for the user. In this example the information comprises product description, discount coupon, or pricing information.

In an embodiment of the present invention the information access tag is an RFID 210. The link to information is stored in memory of the RFID 210 and the RFID 210 is attached to an object. The user device reads the link and retrieves information about the object for the user.

In an embodiment of the present invention the information access tag is a UPC. Similar to the QR code embodiment, a link to an object's additional information is encoded into the UPC. The user device reads the link in the UPC and retrieves the information.

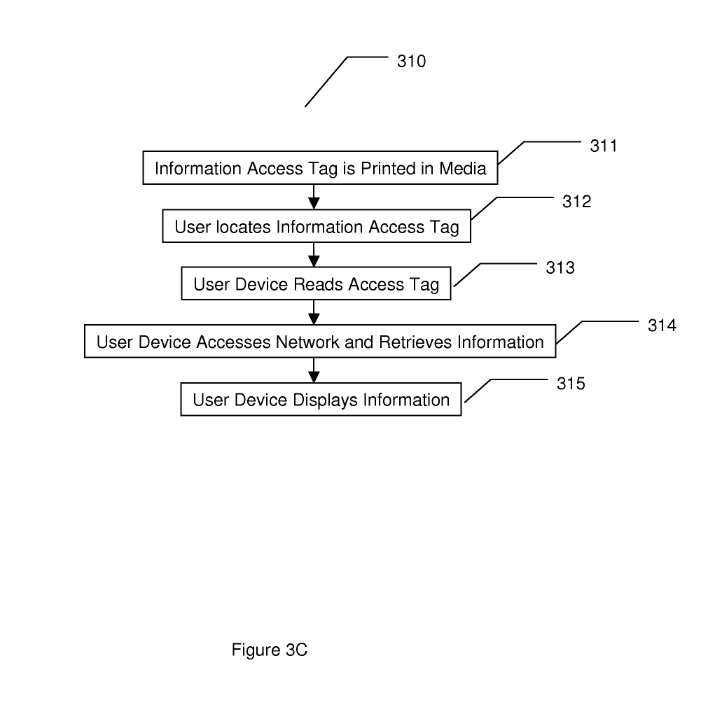

Refer to FIG. 3A, which is a flowchart illustrating a method of acquiring information relevant to an object according to an embodiment of the present invention.

As shown in FIG. 3A, the method 300 comprises placing an information access tag on or in an object in Step 301. The information access tag is printed on, attached to, adhered to, embedded in, or part of the object. The information access tag comprises a link to information relevant to the object. A user locates the information access tag in Step 302 and uses a user device, for example, a mobile electronic device to read the link from the information access tag in Step 303. The user device accesses a network, for example, the Internet and uses the link to locate a server where information about the object is stored and retrieves the information in Step 304. The retrieved information is then displayed on the user device in Step 305.

Refer to FIG. 3B, which is a flowchart illustrating a method of acquiring information relevant to an object according to an embodiment of the present invention.

The embodiment illustrated in FIG. 3B is similar to the embodiment in FIG. 3A. However, in the embodiment of FIG. 3B the user device automatically detects the information access tag and reads the link in the information access tag. In this embodiment the user does not need to locate the information access tag.

As an example of an application using the method of the present invention the following scenario is given. A museum attaches an RFID tag on or next to a piece of art. As a visitor approaches the piece of art the user device detects the RFID tag and accesses the network to retrieve information about the piece of art such as artist, artist biography or background, digital reproductions of the artwork, or screen wallpaper. In this way, the method provides a portable tour guide for the museum.

Refer to FIG. 3C, which is a flowchart illustrating a method of acquiring information relevant to an object according to an embodiment of the present invention.

The method 310 comprises printing an information access tag in a print medium in Step 311. Encoded in the information access tag is a link to a network server where relevant information is stored. A reader of the print medium locates the information access tag in Step 312 and users a portable user device to read the link in Step 313. The user device then accesses a network and using the link locates the network server and retrieves the relevant information in Step 314. The information is then displayed on the user device in Step 315.

As an example of an application using the method of the present invention the following scenario is given. A beverage company has an advertisement printed in a popular magazine introducing a new soft drink. A QR code is printed in a part of the advertisement. The QR code contains a URL pointing to the Internet address of a network server. Information such as description of the drink, multimedia advertisements, discount coupons, retail outlet locations, and special offers is stored on the server. A reader seeing the advertisement uses the camera on their mobile telephone to read the QR code. The mobile telephone accesses the Internet and using the URL in the QR code locates the server and retrieves the various types of information. The information is then displayed on the mobile phone and the user can interact with the information.

In another embodiment of the present invention the information access tag is displayed on a television or computer monitor. The user uses their portable device to read the displayed information access tag and the relevant information is retrieved. For example, a home shopping channel can display the information access tag such as a QR code while describing a product. In this way the user can easily retrieve additional information about the product or can easily place an order for the product. This embodiment also allows users to immediately retrieve information or place orders when viewing commercials during a broadcast. A small portion of the screen displays the information access tag during the commercial and a user uses their mobile device to read the information access tag.

In another embodiment of the present invention a plurality of information access tags are utilized. For example, one information access tag links to product information and another information access tag links to a product order service.

The method of the present invention is utilized in a wide variety of applications. For example, a product's user manual is stored in electronic format on a central server. When a user needs more information about using the product the user simply uses the information access tag on the product with a portable device to access the user manual. The user doesn't have to input model number or other information. As a result, users can easily obtain additional information about the product.

Another application allows a user to obtain travel directions on how to get to a certain location by reading the information access tag on a map or picture. A user can also get recipes that call for a product by reading the information access tag on the product.

Another application allows a user to obtain translations of relevant information. For example, if a label of a product is written in a language the consumer does not understand, reading the information access tag provides the relevant information in the user's language of choice.

Additionally, since the information access tag stays with the object, relevant information can be retrieved at any time during the lifetime of the object.

In some embodiments of the present invention the user selects which type of information to retrieve. The user can select from different categories of information depending on the type of information desired. For example, if a user is looking at a product and wants to know the ingredients they can select nutritional data.

In some embodiments the retrieved relevant information is presented in a format where the user selects from a menu or list of available information.

In some embodiments a list or menu of the available relevant information is presented to the user prior to retrieval. The user selects which information to retrieve.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of acquiring relevant information about an object comprising:
reading an information access tag associated with the object using a portable electronic device;
accessing a location where the relevant information is stored;
retrieving the relevant information; and
displaying the relevant information on the portable electronic device.

2. The method of acquiring relevant information about an object of claim 1, further comprising attaching the information access tag to the object.

3. The method of acquiring relevant information about an object of claim 1, further comprising printing the information access tag in a print medium.

4. The method of acquiring relevant information about an object of claim 1, the information access tag comprising a quick response (QR) code, a radio frequency (RF) tag, a radio frequency identification (RFID) tag, or a universal product code (UPC).

5. The method of acquiring relevant information about an object of claim 1, the information access tag comprising a link to the location of the relevant information.

6. The method of acquiring relevant information about an object of claim 5, the link comprising a universal resource locator (URL).

7. The method of acquiring relevant information about an object of claim 1, the portable electronic device comprising a cellular phone, a personal digital assistant (PDA), or a portable computer.

8. The method of acquiring relevant information about an object of claim 1, the relevant information comprising object explanation, warranty information, competitive pricing, tour information, tutorial, product description, object description, pricing comparison, recipe, discount coupon, user instructions, travel directions, or a combination of these.

9. A method of acquiring relevant information about an object comprising:
reading an information access tag associated with the object to obtain a link to the relevant information;
accessing a location pointed to by the link;
retrieving the relevant information; and
displaying the relevant information on a user device.

10. The method of acquiring relevant information about an object of claim 9, further comprising attaching the information access tag to the object.

11. The method of acquiring relevant information about an object of claim 9, further comprising printing the information access tag in a print medium.

12. The method of acquiring relevant information about an object of claim 9, the information access tag comprising a quick response (QR) code, a radio frequency (RF) tag, a radio frequency identification (RFID) tag, or a universal product code (UPC).

13. The method of acquiring relevant information about an object of claim 9, the link comprising a universal resource locator (URL).

14. A method of acquiring relevant information using a mobile electronic device comprising:
associating an information access tag with an object, the information access tag comprising a link to the relevant information;
reading the link by the mobile electronic device;
accessing a network server where the relevant information is stored; and
displaying the relevant information on the mobile electronic device.

15. The method of acquiring relevant information using a mobile electronic device of claim 14, further comprising attaching the information access tag to the object.

16. The method of acquiring relevant information using a mobile electronic device of claim 14, further comprising printing the information access tag in a print medium.

17. The method of acquiring relevant information using a mobile electronic device of claim 14, the information access tag comprising a quick response (QR) code, a radio frequency (RF) tag, a radio frequency identification (RFID) tag, or a universal product code (UPC).

18. The method of acquiring relevant information using a mobile electronic device of claim 14, the link comprising a universal resource locator (URL).

19. The method of acquiring relevant information using a mobile electronic device of claim 14, the mobile electronic device comprising a cellular phone, a personal digital assistant (PDA), or a portable computer.

20. The method of acquiring relevant information using a mobile electronic device of claim 14, the relevant information comprising object explanation, warranty information, competitive pricing, tour information, tutorial, product description, object description, pricing comparison, recipe, discount coupon, user instructions, travel directions, or a combination of these.
